(19) United States
(12) Patent Application Publication
(10) Pub. No.: US 2016/0283672 A1
(43) Pub. Date: Sep. 29, 2016

(54) METHOD, APPARATUS, AND COMPUTER PROGRAM PRODUCT FOR ASSEMBLING HIERARCHY-INDEPENDENT DATA RELATING TO GEOSPATIAL DATA OF A HEALTH INFORMATION SYSTEM

(71) Applicant: McKesson Corporation, San Francisco, CA (US)

(72) Inventors: Bryan Self, Birmingham, AL (US); Josh Turner, Hueytown, AL (US); Preston Prewett, Sylvan Springs, AL (US)

(21) Appl. No.: 14/670,812

(22) Filed: Mar. 27, 2015

(51) Int. Cl. G06F 19/00

(52) U.S. Cl. CPC G06F 19/327

(57) ABSTRACT

A healthcare information processing apparatus, method and computer program product are provided for creating and configuring logical units, and providing hierarchy-independent data associated with physical units, logical units, and/or facilities. Physical units may be defined by subunits having a common or similar physical location. A logical unit may include a user-configured grouping of subunits selected without regard to physical locations. Upon request from a client terminal, hierarchy-independent data, including accumulated summary data may be provided for any number of physical units, logical units, and/or facilities. Users associated with roles of varying levels within an organization may therefore easily access desired data, independent of hierarchies of the respective data.

### TECHNOLOGICAL FIELD

Embodiments of the present invention relate generally to computer technology and, more particularly, to methods, apparatuses, and computer program products for reporting hierarchy-independent data relating to geospatial data of a health information system.

### BACKGROUND

The widespread use of modern computing technology has led to an increasing demand for access to data. In particular, health information systems that provide the data infrastructure of hospitals, outpatient care, and/or the like capture and log large amounts of data in databases and data repositories. Users of such systems desire intuitive and efficient methods to access, view, and organize data such that workflows may be improved, and patient, staff, and facility statuses may be efficiently monitored.

Therefore, the urgency to access large amounts of pertinent data in an efficient manner has led to an increase in demand for visual data. The healthcare industry, among others, is one that utilizes geospatial arrangements to convey information in a visual format, efficiently and effectively to various units and individuals, such as throughout a hospital, for example. Health information systems may provide geospatial arrangements such that doctors and staff may view a floor plan of patient rooms for a particular floor of a hospital to manage workflows and attend to patients. Real-time or near real-time data is captured relative to the geospatial data. The extensive information relating to a specified location or area of a building may therefore be presented in a single visual representation. However, in some examples, although configured for visual representation on a geospatial arrangement, the data desired by a user may be too expansive or granular to utilize on such an arrangement.

### BRIEF SUMMARY OF SOME EXAMPLE EMBODIMENTS

A method, computer program product and apparatus for assembling hierarchy-independent data relating to geospatial data are therefore provided. In this regard, geospatial data may be collected relative to various hierarchies represented within a geospatial arrangement. Entities may exist within the geospatial information system that encompass or include other entities. In some examples, lower level entities may be wholly included in another or several other higher level entities. Furthermore, some entities may span several entities of varying classification, and therefore may not be easily placed within such a hierarchy. As used herein, the term ‘hierarchy’ may therefore refer to an organization or classification of entities based on inclusiveness or a lack of inclusiveness relative to other entities.

Many data reporting applications retrieve data via processes dependent on an entity's classification within a hierarchy. Therefore, it may be beneficial to enable provision of data in a format independent of such hierarchies such that data relating to entities not clearly classified with respect to a hierarchy may nevertheless be provided and compared to other data.

Example embodiments provide data relating to physical units, logical units, and/or facilities, independent of the hierarchy of such data. Physical units comprise subunits (e.g., rooms) in a similar or common location and may be considered as classified at a higher level hierarchy than subunits, and in some examples, a logical unit. Logical units include manually selected subunits and/or physical units configured by users, and may span any level of a hierarchy as they may include physical units, individual subunits, and/or facilities. Facilities may include pre-defined subunits such as all the known rooms in a facility, and may be considered to be a high level entity in a hierarchy. The data relating to any of the physical units, logical units, and/or facilities may therefore be provided independently of their respective hierarchies. In some examples, accumulated summary data may be provided for each physical unit, logical unit, and/or facility selected, and for each selected data field.

A healthcare information processing apparatus is provided, for assembling hierarchy-independent data relating to geospatial data of a health information system. The healthcare information processing apparatus comprises processing circuitry configured to cause the healthcare information processing apparatus to perform at least receiving an indication of a subject selection comprising at least one of each of a physical unit and a logical unit. Each of the physical units is defined based on a physical location, and each of the selected logical units is defined based on a user-configured grouping of individual subunits. The method also includes receiving an indication of a selection of at least one data field and accessing data defining the subject selection. The data identifies the individual subunits of the subject selection. The method also includes accessing captured status data associated with the selected at least one data field and relating to the individual subunits of the subject selection, and calculating accumulated physical unit summary data for the selected physical unit based on the at least one selected data field for the individual subunits of the physical unit. The method further includes calculating accumulated logical unit summary data for the selected logical unit based on the at least one selected data field for the individual subunits of the user-configured grouping, and causing display of the accumulated physical unit summary data for the selected physical unit with the accumulated logical unit summary for the selected logical unit.

In some embodiments, the individual subunits of the logical unit are each defined based on respective physical locations and the logical unit is collectively defined without regard to the physical locations of the individual subunits.

In some examples, the processing circuitry may be further configured to cause the healthcare information processing apparatus to perform at least storing the indication of the subject selection in association with the indication of the selection of the at least one data field and a unique identifier of a report, providing the unique identifier for subsequent retrieval of the report, and in response to subsequent retrieval of the report, calculating current status data.

In some examples, the subject selection further comprises at least one facility, wherein each of the respective facilities is defined based on all predefined subunits physically located in the respective facility. In these examples, the processing circuitry is further configured to cause the healthcare information processing apparatus to perform at least: accessing captured status data relating to each of the predefined subunits of the respective facilities, calculating accumulated facility summary data for the at least one selected facility based on the at least one selected data field for the predefined subunits, and causing display of the accumulated facility summary data for the at least one selected facility. In this embodiment, the displayed accumulated logical unit summary data for the selected logical unit and the accumulated physical unit summary data relate to the directly selected physical units.

In some embodiments, the processing circuitry is further configured to cause the healthcare information processing apparatus to perform at least receiving an indication of at least one of a threshold minimum or threshold maximum associated with at least one selected data field. In response to any of accumulated logical unit summary data or accumulated physical unit summary data exceeding the threshold maximum or falling below the threshold minimum, the processing circuitry is configured to cause display of the respective accumulated logical unit summary data or accumulated physical unit summary data in a distinguished format.

In some embodiments, the at least one selected data field comprises a temporal data field, and an associated accumulated summary data comprises an average time. In some examples, the at least one selected data field comprises a quantitative data field, and an associated accumulated summary data comprises a sum.

A method is also provided for assembling hierarchy-independent data relating to geospatial data of a health information system. The method comprises: receiving an indication of a subject selection comprising at least one of each of a physical unit and a logical unit. Each of the physical units is defined based on a physical location, and each of the selected logical units is defined based on a user-configured grouping of individual subunits. The method also includes receiving an indication of a selection of at least one data field, and accessing data defining the subject selection. The data identifies the individual subunits of the subject selection. The method also includes accessing captured status data associated with the selected at least one data field and relating to the individual subunits of the subject selection, and calculating accumulated physical unit summary data for the selected physical unit based on the at least one selected data field for the individual subunits of the physical unit. The method further includes calculating accumulated logical unit summary data for the selected logical unit based on the at least one selected data field for the individual subunits of the user-configured grouping, and causing display of the accumulated physical unit summary data for the selected physical unit with the accumulated logical unit summary for the selected logical unit.

In some examples, the individual subunits of the logical unit are each defined based on respective physical locations and the logical unit is collectively defined without regard to the physical locations of the individual subunits.

In some embodiments, the method includes storing the indication of the subject selection in association with the indication of the selection of the at least one data field and a unique identifier of a report, providing the unique identifier for subsequent retrieval of the report, and in response to subsequent retrieval of the report, calculating current status data.

In some embodiments, the subject selection further comprises at least one facility, wherein each of the respective facilities is defined based on all predefined subunits physically located in the respective facilities. In these embodiments, the method further comprises: accessing captured status data relating to each of the predefined subunits of the respective facilities, calculating accumulated facility summary data for the at least one selected facility based on the at least one selected data field for the predefined subunits, and causing display of the accumulated facility summary data for the at least one selected facility. In this embodiment, the displayed accumulated logical unit summary data for the selected logical unit and the accumulated physical unit summary data relating to the directly selected physical units.

In some examples, the method includes receiving an indication of at least one of a threshold minimum or threshold maximum associated with at least one selected data field. In response to any of accumulated logical unit summary data or accumulated physical unit summary data exceeding the threshold maximum or falling below the threshold minimum, the method of these example embodiments also includes causing display of the respective accumulated logical unit summary data or accumulated physical unit summary data in a distinguished format.

In some embodiments, the at least one selected data field comprises a temporal data field, and an associated accumulated summary data comprises an average time. The at least one selected data field may comprise a quantitative data field, and an associated accumulated summary data comprises a sum.

A computer program product is also provided, for assembling hierarchy-independent data relating to geospatial data of a health information system. The computer program product comprises at least one non-transitory computer-readable medium having computer-readable program instructions stored therein. The computer-readable program instructions comprise instructions, which when performed by an apparatus, are configured to cause the apparatus to perform at least receiving an indication of a subject selection comprising at least one of each of a physical unit and a logical unit. Each of the physical units is defined based on a physical location, and each of the selected logical units is defined based on a user-configured grouping of individual subunits. The computer-readable program instructions are also configured to cause the apparatus to receive an indication of a selection of at least one data field, access data defining the subject selection, wherein the data identifies the individual subunits of the subject selection, and access captured status data associated with the selected at least one data field and relating to the individual subunits of the subject selection. The computer-readable program instructions are further configured to cause the apparatus to calculate accumulated physical unit summary data for the selected physical unit based on the at least one selected data field for the individual subunits of the physical unit, calculate accumulated logical unit summary data for the selected logical unit based on the at least one selected data field for the individual subunits of the user-configured grouping, and cause display of the accumulated physical unit summary data for the selected physical unit with the accumulated logical unit summary for the selected logical unit.

An apparatus is also provided for assembling hierarchy-independent data relating to geospatial data of a health information system. The apparatus comprises means for receiving an indication of a subject selection comprising at least one of each of a physical unit and a logical unit. Each of the physical units is defined based on a physical location, and each of the selected logical units is defined based on a user-configured grouping of individual subunits. The apparatus also includes means for receiving an indication of a selection of at least one data field, and means for accessing data defining the subject selection. The data identifies the individual subunits of the subject selection. The apparatus also includes means for accessing captured status data associated with the selected at least one data field and relating to the individual subunits of the subject selection, and means for calculating accumulated physical unit summary data for the selected physical unit based on the at least one selected data field for the individual subunits of the physical unit. The apparatus further includes means for calculating accumulated logical unit summary data for the selected logical unit based on the at least one selected data field for the individual subunits of the user-configured grouping, and means for causing display of the accumulated physical unit summary data for the selected physical unit with the accumulated logical unit summary for the selected logical unit.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the disclosure in any way. It will be appreciated that the scope of the disclosure encompasses many potential embodiments, some of which will be further described below, in addition to those here summarized.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIG. 1 is an example geospatial arrangement, according to prior art;

FIG. 2 is a block diagram of a system used in the configuration of logical units assembly of hierarchy-independent data, according to some example embodiments;

FIG. 3 is a block diagram of an apparatus used in the configuration of logical units and/or the assembly of hierarchy-independent data, according to some example embodiments;

FIG. 4 is a flowchart of operations for creating a logical unit according to some example embodiments;

FIG. 5 is an example display used for creating a logical unit according to some example embodiments;

FIG. 6 is an example display for displaying a graphical logical unit according to some example embodiments;

FIG. 7 is an example display used for configuring a graphical logical unit according to some example embodiments;

FIG. 8 is a flowchart of operations for assembling hierarchy-independent data according to some example embodiments;

FIGS. 9A and 9B are example displays used to configure the assembly of hierarchy-independent data according to some example embodiments; and

FIGS. 10 and 11 are example displays of assembled hierarchy-independent data, according to some example embodiments.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As used herein, where a computing device is described to receive data from another computing device, it will be appreciated that the data may be received directly from the other computing device and/or may be received indirectly via one or more intermediary computing devices, such as, for example, one or more servers, relays, routers, network access points, and/or the like. Similarly, where a computing device is described herein to transmit data to another computing device, it will be appreciated that the data may be sent directly to the other computing device or may be sent to the other computing device via one or more interlinking computing devices, such as, for example, one or more servers, relays, routers, network access points, and/or the like.

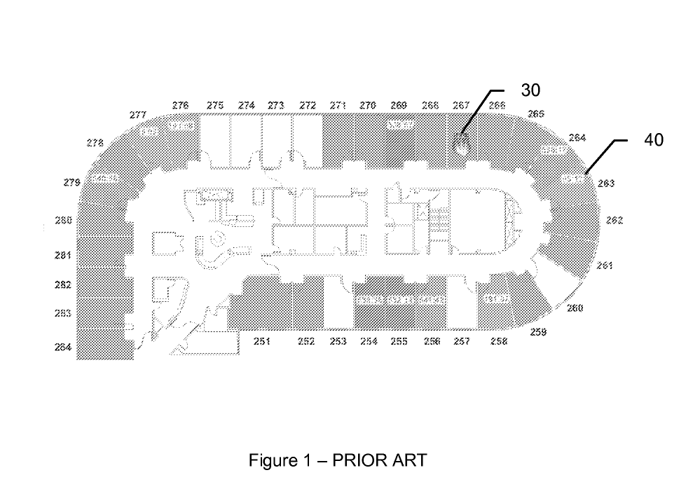

FIG. 1 illustrates a geospatial arrangement of a physical unit. In this example, the physical unit is a hospital floor. A physical unit may be considered a collection of subunits having a common or similar physical location. The geospatial arrangement provides information for the physical unit, and in this case, the entire floor room by room. Some rooms, or subunits, are color coded to provide statuses of rooms or patients assigned to the rooms. For example, for a cleaning crew, the geospatial arrangement may show color coded rooms to indicate which rooms are cleaned and which rooms are in need of cleaning. As an alternative use, the rooms may be color coded to indicate which rooms are occupied or vacant. Further, icon 30 indicates that an alarm has signaled in room 267, and timer 40 on room 263 indicates a countdown until a specified event or an elapsed time since a previously occurring event. The example geospatial arrangement may therefore provide pertinent information related to an entire floor of the hospital in a visual format easily interpreted by a user. A physical unit need not include an entire hospital floor, but in some examples may be defined by a subset of physically co-located rooms, such as a portion of a floor, associated with a particular clinical unit. Said differently, a physical unit may include subunits in a similar or common location as defined by underlying geospatial data. For example, a physical unit named “Operating room” or “OR” may include all rooms in the operating room area of a facility.

In practical use, a user may not need information for an entire physical unit, but may be more interested in particular rooms throughout a building and on different floors. According to an example embodiment, a user may create a logical unit, such that identified rooms may be displayed as a logical unit without regard to their respective geospatial arrangements or underlying geospatial data (e.g., the data defining the respective physical locations of rooms relative to a facility and/or floor in a facility). Logical units are described in further detail in U.S. patent application Ser. No. 14/106,898, filed Dec. 16, 2013 and entitled, “Method, Apparatus, and Computer Program Product for Creating Logical Units,” which is hereby incorporated by reference in its entirety.

According to example embodiments, logical units may be created for a user to create a customized view of information specific to a variety of rooms, floors and/or other locations that otherwise may need to be accessed by viewing a number of different geospatial arrangements. Medical facilities in particular may benefit from configurable logical units so that doctors, managers, or other users overseeing rooms or staff members on a number of different floors, for example, may access the visual information in a consolidated view. Although a hospital is used throughout as an example embodiment, it will be appreciated that the embodiments provided herein may be beneficial to many other fields and uses. The hospital environment is cited as a non-limiting example, and should not be construed to narrow the scope or spirit of the disclosure in any way.

To create a logical unit, a user may select a plurality of subunits (e.g., hospital rooms or any space identifiable by its physical location) to include in a logical unit. A graphical representation of the configured logical unit (e.g., graphical logical unit) may then be accessed so that a user may view pertinent data relating to the particular subunits making up the logical unit. The data defining the logical unit may be stored for subsequent use and retrieval. Example embodiments also provide for cloning and editing of logical units for customized logical units and sharing amongst users.

In addition to accessing data relating to a single configured logical unit, a user may want to access information regarding other rooms, groups of rooms belonging to a common clinical unit or the like, additional logical units, or a facility as a whole. For example, some users in working in management, hospital administration, health information system data administration, and/or the like, may require access to larger volumes of data spanning multiple configured logical units, physical units, rooms, entire facilities, and/or the like. In such examples, it may be impractical to display the vast amount of data required in the graphical format of geospatial arrangements or graphical logical units.

Therefore, according to example embodiments, hierarchy-independent data may be assembled such that a user may efficiently access data relating to any number of subunits, logical units, and/or facilities, regardless of the hierarchy of the data. For example, a logical unit has a higher hierarchy than a subunit, because a logical unit may include multiple subunits. A logical unit may have a same or lower hierarchy than a facility, because a logical unit may be configured to include all subunits in a facility, or as in many examples, only a subset of subunits in a facility. In some examples, the classification of a logical unit within a hierarchy may therefore be unknown or undefined, and there may be a challenge in retrieving and presenting the data in a format compatible with other clearly classified entities within the hierarchy. The assembly of the hierarchy-independent data is described in further detail hereinafter.

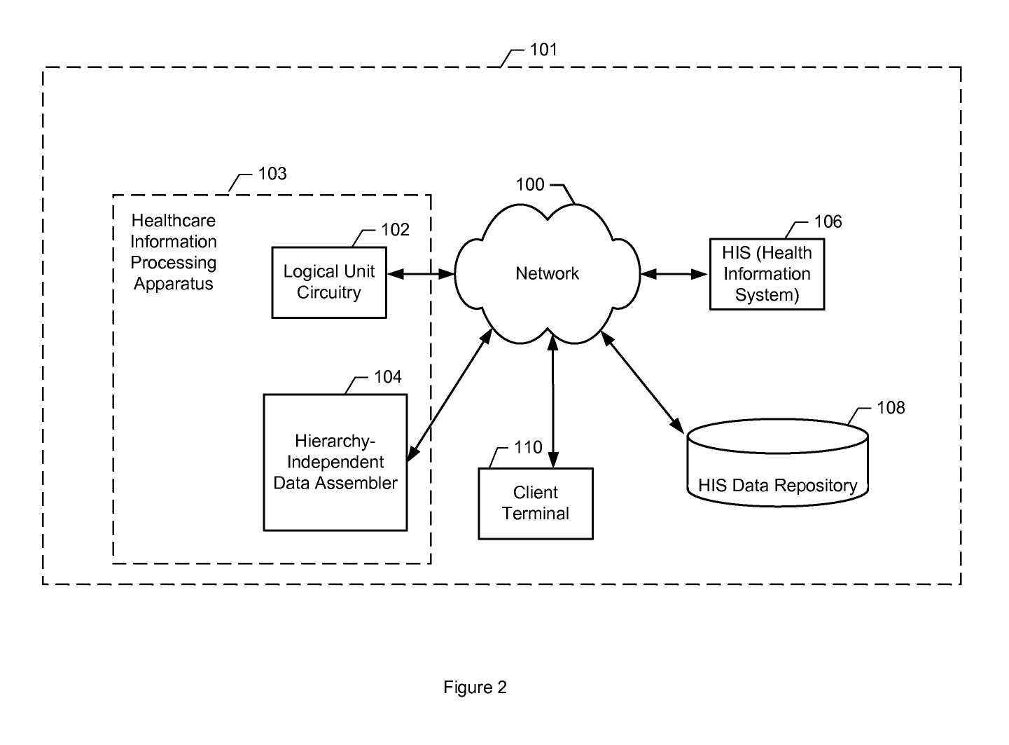

FIG. 2 illustrates a system 101 for creating logical units and providing hierarchy-independent data according to some example embodiments. It will be appreciated that the system 101, as well as the illustrations in other figures, are each provided as an example of an embodiment(s) and should not be construed to narrow the scope or spirit of the disclosure in any way. In this regard, the scope of the disclosure encompasses many potential embodiments in addition to those illustrated and described herein. As such, while FIG. 2 illustrates one example of a configuration of a system, numerous other configurations may also be used to implement embodiments of the present invention.

The system 101 may include a network 100, logical unit circuitry 102, healthcare information processing apparatus 103, hierarchy-independent data assembler 104, health information system (HIS) 106, HIS data repository 108, and/or a client, such as a client terminal 110. In some example embodiments, logical unit circuitry 102 and/or hierarchy-independent data assembler 104 may be implemented on the same computing devices, or may be respectively embodied as or comprise one or more computing devices. In some example embodiments, logical unit circuitry 102 and/or hierarchy-independent data assembler 104 may be implemented as a distributed system or a cloud based entity that may be implemented within network 100. In this regard, logical unit circuitry 102 and/or hierarchy-independent data assembler 104 may comprise one or more servers, a server cluster, one or more network nodes, a cloud computing infrastructure, some combination thereof, or the like. Therefore, as another example, the logical unit circuitry 102 and/or hierarchy-independent data assembler 104 may be referred to as a healthcare information processing apparatus 103, which may be configured to perform any of the operations of the logical unit circuitry 102 and/or the hierarchy-independent data assembler 104 described herein.

Logical unit circuitry 102 may be configured to maintain logical units and provide the graphical logical units for display by a client terminal 110. A logical unit may be considered data or information relative to a grouping of subunits, each subunit being defined based on a physical location (e.g., a room on a floor of a building, address, or other geographical location). A graphical logical unit may therefore refer to the display of such subunits, without regard to their respective geospatial arrangements.

According to the example embodiments provided herein, logical unit circuitry 102 may be further configured to receive real-time or near real-time information related to any of the subunits, such as from HIS 106, for example, apply the information to a logical unit, and provide the graphical logical unit to client terminal 110. Graphical logical units may be provided to client terminal 110 via a web application, for example. In this regard, logical unit circuitry 102 may additionally or alternatively be implemented as a web server. In some embodiments, raw data regarding the logical units may be transmitted from the logical unit circuitry 102 to the client terminal 110, and an application installed on the client terminal 110 may generate the graphical logical unit for display.

Hierarchy-independent data assembler 104 may be configured to access data from any of the logical unit circuitry 102, HIS 106, HIS data repository 108, and/or the like. The hierarchy-independent data assembler 104 may access, process, and assemble the data according to user instructions or configurations provided via client terminal 110. The assembly of the data by the hierarchy-independent data assembler 104 is described in further detail hereinafter. The assembled hierarchy-independent data may be provided to the client terminal 110, for display via a user interface, for example.

The HIS(s) 106 may be configured to communicate with logical unit circuitry 102 and/or hierarchy-independent data assembler 104 over network 100, for example. HIS 106 may be embodied as or comprise one or more computing devices. In some example embodiments, HIS 106 may be implemented as a distributed system or a cloud based entity that may be implemented within network 100. In this regard, HIS 106 may comprise one or more servers, a server cluster, one or more network nodes, a cloud computing infrastructure, some combination thereof, or the like.

In example embodiments provided herein, the HIS 106 may be operative to perform one or more functions associated with the infrastructure of a medical facility (e.g., hospital). For example, a HIS 106 may be used to systematically manage any information such as patient statuses, physician shift schedules, and/or nurse assignments, among others. In some examples, the HIS 106 may be operated by a third party. The term ‘third party’ may be used to emphasize that the HIS 106 may operate independently from logical unit circuitry 102 and/or hierarchy-independent data assembler 104, and/or under different ownership than that of the logical unit circuitry 102 and/or hierarchy-independent data assembler 104, but it will be appreciated that in some embodiments, the HIS 106 may indeed be operated, separately, but nonetheless by the same entity in control of the logical unit circuitry 102 and/or hierarchy-independent data assembler 104. In some embodiments, any of the HIS 106 and logical unit circuitry 102, hierarchy-independent data assembler 104, and/or HIS 106 may be implemented on the same device.

Although FIG. 2 depicts one HIS 106, in some embodiments, any number of health information systems 106 may be present. In example embodiments provided herein, HIS 106 may be configured to provide status data relative to a subunit (e.g. room) to the logical unit circuitry 102, so that information gathered by the HIS 106 may be represented in a visual format on a graphical logical unit. In this regard status data may include any pertinent information relating to a specified subunit, or patient assigned to the subunit, which may be updated in real-time or near-real time, such as every 5 minutes, for example.

In some embodiments, the data provided by HIS 106 may be associated with an entity without regard to physical location, such as a patient or staff member, for example. In such an embodiment, the logical unit circuitry 102 may use room assignment data or other information (which may be provided by a HIS 106), to associate the entity with a physical location or subunit, such that visual representation of the information may be applied to a graphical logical unit.

While HIS 106 provides real-time or near real-time data to various components of system 101, HIS data repository 108 may also provide data, such as persistent data, to the various components of system 101. For example, the hierarchy-independent data assembler 104 may access the HIS data repository 108 to determine a list of subunits or rooms associated with a particular facility. Based on a listing of relevant subunits, the hierarchy-independent data assembler 104 may request status data from the HIS 106 for the identified subunits. In some examples, the HIS data repository 108 may even provide an identifier of a target HIS 106 or interface information such that the hierarchy-independent data assembler 104 can request the desired information from the target HIS 106.

Client terminal 110 may be embodied as a user terminal such as a laptop computer, tablet computer, mobile phone, desktop computer, workstation, or other like computing device. A client terminal 110 may be remote from the logical unit circuitry 102, hierarchy-independent data assembler 104, and/or HIS 106, in which case the user terminal 110 may communicate with any of the respective apparatuses via network 100. Additionally or alternatively, a client terminal 110 may be implemented on a HIS 106. Client terminal(s) 110 may be used to access an application provided by the logical unit circuitry 102 and/or hierarchy-independent data assembler 104, such as a maintenance tool to configure logical units and/or assembly of hierarchy-independent data, or a web application for viewing a graphical logical unit and/or assembled hierarchy-independent data. As such, in example embodiments, physicians, staff, and/or other individuals may use client terminal 110 to view graphical logical units and related pertinent information provided by logical unit circuitry 102, as well as assembled hierarchy-independent data provided by hierarchy-independent data assembler 104.

Communication between client terminal 110 and logical unit circuitry 102 and/or hierarchy-independent data assembler 104 may occur via network 100. The client terminal 110 may request and receive data from the logical unit circuitry 102 and/or hierarchy-independent data assembler 104 in such a manner that the logical unit circuitry 102 and/or hierarchy-independent data assembler 104 operate as a blackbox server. Processing of the information may be performed by the logical unit circuitry 102 and/or hierarchy-independent data assembler 104, deeming the client terminal 110, in some embodiments, a thin client. Any number of client terminals 110 may be present in system 101.

Network 100 may be embodied in a local area network, the Internet, any other form of a network, or in any combination thereof, including proprietary private and semi-private networks and public networks. The network 100 may comprise a wired network, wireless network (e.g., a cellular network, wireless local area network, wireless wide area network, some combination thereof, or the like), or a combination thereof, and in some example embodiments comprises at least a portion of the Internet.

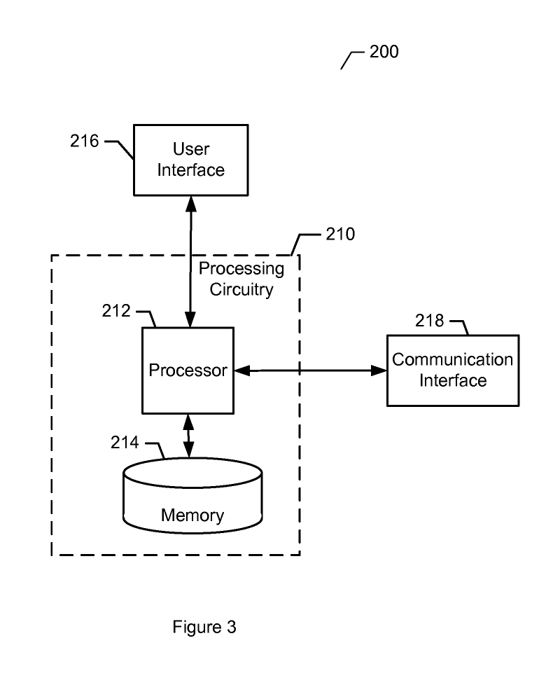

FIG. 3 illustrates an example apparatus 200 that may implement logical unit circuitry 102, healthcare information processing apparatus 103, hierarchy-independent data assembler 104, HIS 106, and/or client terminal 110, in accordance with some example embodiments. However, it should be noted that the components, devices, and elements illustrated in and described with respect to FIG. 3 below may not be mandatory and thus some may be omitted in certain embodiments. For example, FIG. 3 illustrates a user interface 216, as described in more detail below, which may be provided by the client terminal 110, but may be optional in the logical unit circuitry 102, hierarchy-independent data assembler 104, and/or HIS 106. Additionally, some embodiments may include further or different components, devices, or elements beyond those illustrated in and described with respect to FIG. 3.

Continuing with FIG. 3, processing circuitry 210 may be configured to perform actions in accordance with one or more example embodiments disclosed herein. In this regard, the processing circuitry 210 may be configured to perform and/or control performance of one or more functionalities of logical unit circuitry 102, hierarchy-independent data assembler 104, HIS 106, and/or client terminal 110 in accordance with various example embodiments. The processing circuitry 210 may be configured to perform data processing, application execution, and/or other processing and management services according to one or more example embodiments. In some embodiments, logical unit circuitry 102, hierarchy-independent data assembler 104, HIS 106, and/or client terminal 110, or a portion(s) or component(s) thereof, such as the processing circuitry 210, may be embodied as or comprise a computing device, e.g., an integrated circuit or other circuitry. The circuitry may constitute means for performing one or more operations for providing the functionalities described herein.

In some example embodiments, the processing circuitry 210 may include a processor 212, and in some embodiments, such as that illustrated in FIG. 3, may further include memory 214. The processing circuitry 210 may be in communication with or otherwise control a user interface 216, and/or a communication interface 218. As such, the processing circuitry 210 may be embodied as a circuit chip (e.g., an integrated circuit) configured (e.g., with hardware, software, or a combination of hardware and software) to perform operations described herein.

The processor 212 may be embodied in a number of different ways. For example, the processor 212 may be embodied as various processing means such as one or more of a microprocessor or other processing element, a coprocessor, a controller, or various other computing or processing devices including integrated circuits such as, for example, an ASIC (application specific integrated circuit), an FPGA (field programmable gate array), or the like. Although illustrated as a single processor, it will be appreciated that the processor 212 may comprise a plurality of processors. The plurality of processors may be in operative communication with each other and may be collectively configured to perform one or more functionalities of logical unit circuitry 102, hierarchy-independent data assembler 104, HIS 106, and/or client terminal 110 as described herein. The plurality of processors may be embodied on a single computing device or distributed across a plurality of computing devices collectively configured to function as logical unit circuitry 102, hierarchy-independent data assembler 104, HIS 106, and/or client terminal 110. In some example embodiments, the processor 212 may be configured to execute instructions stored in the memory 214 or otherwise accessible to the processor 212. As such, whether configured by hardware or by a combination of hardware and software, the processor 212 may represent an entity (e.g., physically embodied in circuitry—in the form of processing circuitry 210) capable of performing operations according to embodiments of the present invention while configured accordingly. Thus, for example, when the processor 212 is embodied as an ASIC, FPGA, or the like, the processor 212 may be specifically configured hardware for conducting the operations described herein. Alternatively, as another example, when the processor 212 is embodied as an executor of software instructions, the instructions may specifically configure the processor 212 to perform one or more operations described herein.

In some example embodiments, the memory 214 may include one or more non-transitory memory devices such as, for example, volatile and/or non-volatile memory that may be either fixed or removable. In this regard, the memory 214 may comprise a non-transitory computer-readable storage medium. It will be appreciated that while the memory 214 is illustrated as a single memory, the memory 214 may comprise a plurality of memories. The plurality of memories may be embodied on a single computing device or may be distributed across a plurality of computing devices collectively configured to function as logical unit circuitry 102, hierarchy-independent data assembler 104, HIS 106, and/or client terminal 110. The memory 214 may be configured to store information, data, applications, instructions and/or the like for enabling logical unit circuitry 102, hierarchy-independent data assembler 104, HIS 106, and/or client terminal 110 to carry out various functions in accordance with one or more example embodiments. For example, the memory 214 may be configured to buffer input data for processing by the processor 212. Additionally or alternatively, the memory 214 may be configured to store instructions for execution by the processor 212. As yet another alternative, the memory 214 may include one or more databases that may store a variety of files, contents, or data sets. For example, when apparatus 200 is implemented as logical unit circuitry 102, the memory 214 may be configured to store logical units. In embodiments in which apparatus 200 is implemented as hierarchy-independent data assembler 104, the memory 214 may be configured to store configurations of physical units, logical units, and/or facilities. Among the contents of the memory 214, applications may be stored for execution by the processor 212 to carry out the functionality associated with each respective application. In some cases, the memory 214 may be in communication with one or more of the processor 212, user interface 216, and/or communication interface 218, for passing information among components of logical unit circuitry 102, hierarchy-independent data assembler 104, HIS 106, and/or client terminal 110.

The user interface 216 may be in communication with the processing circuitry 210 to receive an indication of a user input at the user interface 216 and/or to provide an audible, visual, mechanical, or other output to the user. As such, the user interface 216 may include, for example, a keyboard, a mouse, a joystick, a display, a touch screen display, a microphone, a speaker, and/or other input/output mechanisms. As such, the user interface 216 may, in some example embodiments, provide means for user control of managing or processing data access operations and/or the like. In some example embodiments in which logical unit circuitry 102, hierarchy-independent data assembler 104, and/or HIS 106 is embodied as a server, cloud computing system, or the like, aspects of user interface 216 may be limited or the user interface 216 may not be present. Accordingly, regardless of implementation, the user interface 216 may provide input and output means in accordance with one or more example embodiments, such as displaying a graphical logical unit, and/or providing an interface for configuring selections of physical units, logical units, and/or facilities.

The communication interface 218 may include one or more interface mechanisms for enabling communication with other devices and/or networks. In some cases, the communication interface 218 may be any means such as a device or circuitry embodied in either hardware, or a combination of hardware and software that is configured to receive and/or transmit data from/to a network and/or any other device or module in communication with the processing circuitry 210. By way of example, the communication interface 218 may be configured to enable communication among logical unit circuitry 102, hierarchy-independent data assembler 104, HIS 106, and/or client terminal 110 via network 100. Accordingly, the communication interface 218 may, for example, include supporting hardware and/or software for enabling wireless and/or wireline communications via cable, digital subscriber line (DSL), universal serial bus (USB), Ethernet, or other methods.

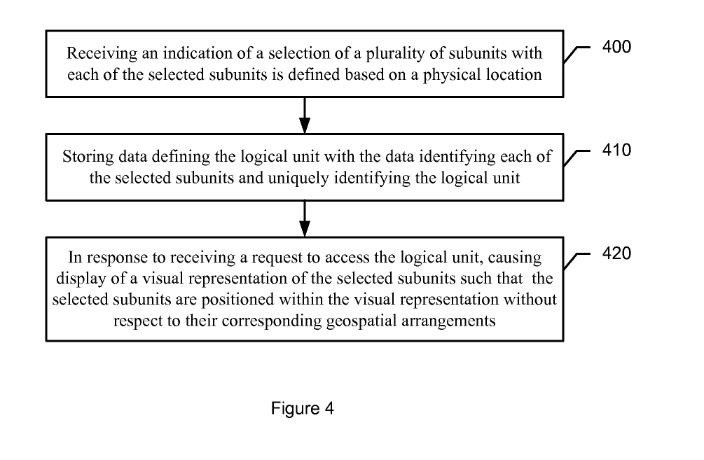

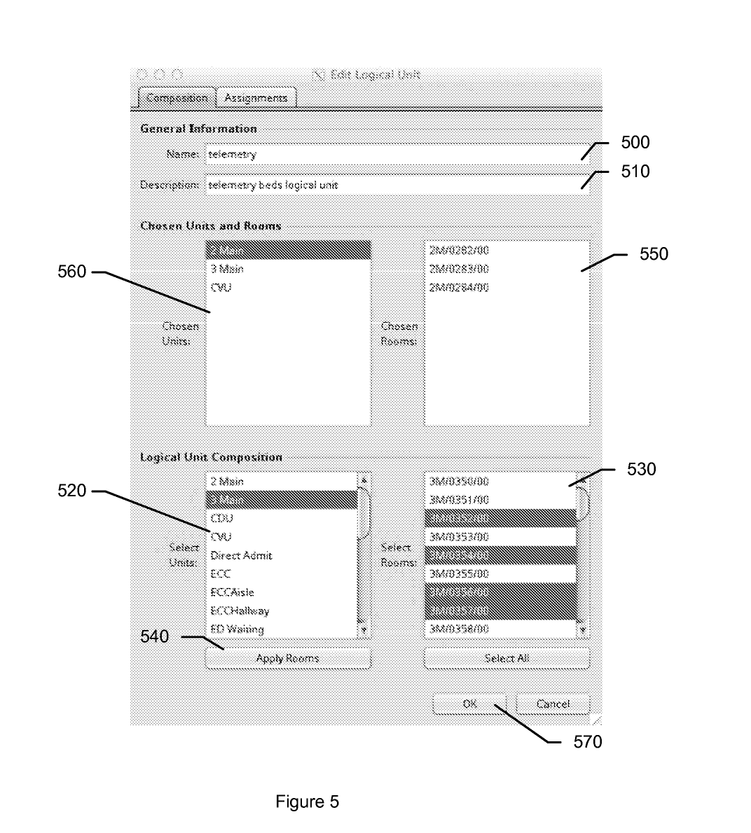

FIG. 4 is a flowchart illustrating example operations of logical unit circuitry 102 according to an example embodiment. As shown by operation 400, the healthcare information processing apparatus 103 and/or logical unit circuitry 102 may be configured, such as with processor 212, memory 214, user interface 216, communication interface 218 and/or the like, for receiving an indication of a selection of a plurality of subunits, wherein each of the selected subunits is defined based on a physical location. A user may therefore access a user interface provided by the healthcare information processing apparatus 103 and/or logical unit circuitry 102 on client terminal 110, for example, to select any number of subunits, such as rooms in a building. An example display for selecting subunits is provided and described in more detail with respect to FIG. 5.

Although the subunits may be defined based on their physical location, such as room number and/or on a floor of a building, a user may desire to select rooms based on some other characteristic, such as a type of patient or treatment, practice group, patient status, meal selection, and/or level of care, for example. A user may therefore select some characteristic of a subunit other than the physical location, and the healthcare information processing apparatus 103 and/or logical unit circuitry 102 may identify the applicable subunits based on information provided by a HIS 106, for example.

As shown by operation 410, the healthcare information processing apparatus 103 and/or logical unit circuitry 102 may be configured, such as with processor 212, memory 214, and/or the like, for storing data defining the logical unit, wherein the data identifies each of the selected subunits and uniquely identifies the logical unit. A logical unit may therefore be named by a user to allow the user to later identify the logical unit. The name, or another unique identifier may be stored and associated with data identifying the subunits (e.g., any data identifying the rooms, such as room and floor numbers). The data may be stored to memory 214 so that it may be retrieved by a user requesting to view the graphical logical unit.

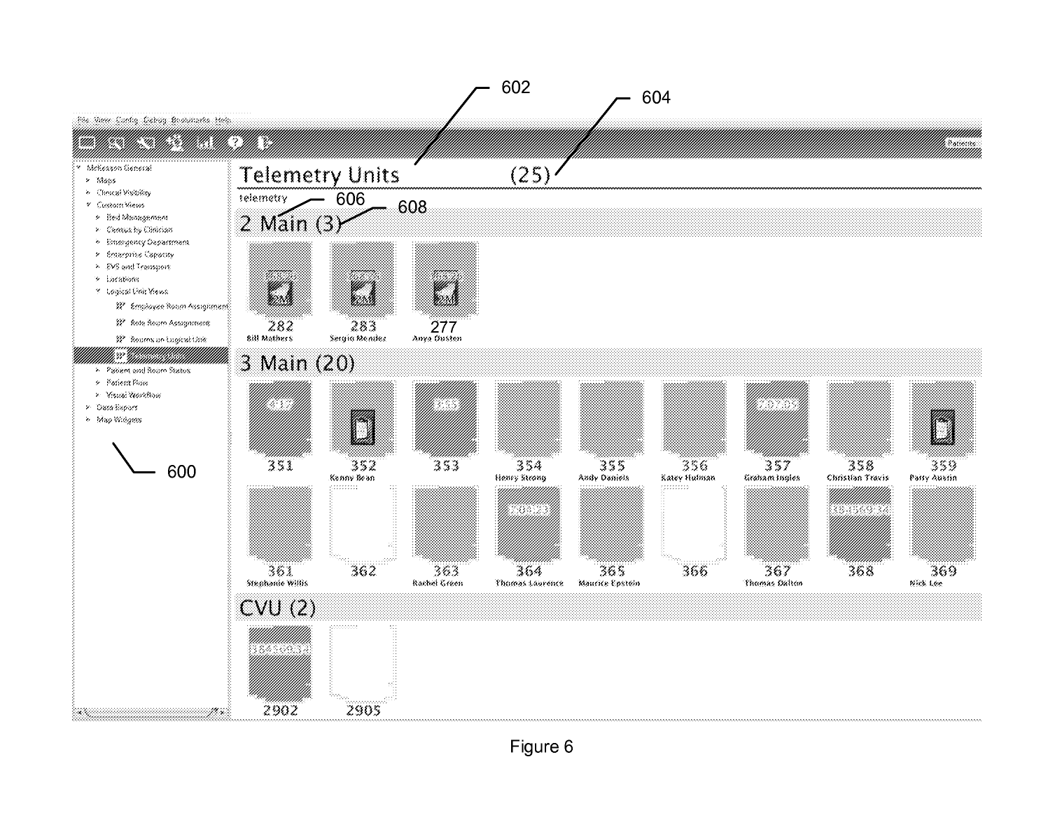

As shown by operation 420, the healthcare information processing apparatus 103 and/or logical unit circuitry 102 may be configured for, in response to receiving a request to access the logical unit, causing display of a visual representation (e.g., graphical logical unit) of the selected subunits, wherein the selected subunits are positioned within the visual representation without respect to their corresponding geospatial arrangements. An example of a visual representation, or graphical logical unit, is provided and described with respect to FIG. 6.

In some embodiments, the visual representation may convey pertinent information specific to at least one subunit. For example, information received from a HIS 106 may indicate that lunch is currently being served to a patient in a particular room. The healthcare information processing apparatus 103 and/or logical unit circuitry 102 may therefore apply an icon or other visual indication of the information to the particular room, and provide the graphical logical unit to the client terminal 110 for display.

In some embodiments, the visual representation may group the subunits based on their respective physical locations, such as a floor, for example. Regardless of whether the subunits are grouped, the subunits may be positioned or placed without respect to their physical locations relative to other subunits. Said differently, the subunits may be displayed or represented without respect to a geospatial arrangement, floor plan, or layout. While the example geospatial arrangement provided in FIG. 1 is a floor plan, it will be appreciated that a geospatial arrangement may be considered any data providing information regarding the physical location of a subunit with respect to another subunit, subunits, and/or all available subunits. Such embodiments may allow for improved utilization of a display screen to display the subunits, or rooms. Otherwise, a user may need to access several display screens to view different geospatial arrangements covering the subunits of interest. Using embodiments provided herein, a user may configure a graphical logical unit to provide information regarding rooms or subunits located on several different floors, on a single display screen, or reduced number of display screens, in comparison to viewing all applicable geospatial arrangements. The selected subunits of interest need not be physically adjacent. An example graphical logical unit is provided and described in further detail with respect to FIG. 6.

FIG. 5 is an example display used for creating or editing a logical unit. Such a display may be provided on a client terminal 110, for example. A user may provide a name and description of the logical unit in input areas 500 and 510, for example. A user may view available units in selection box 520. According to this example embodiment, a user may select a floor or other defined area in a building. In response, selection box 530 may update with available rooms (or subunits) in the selected unit. A user may then select the rooms of interest to be added to the logical unit. Upon selection of the “Apply Rooms” button 540, the selected rooms and respective units may be displayed in areas 550 and 560, respectively. Selection of a unit in area 560 may cause the area 550 to update to display only rooms from the selected unit to be included in the logical unit. In some embodiments, the rooms may not necessarily be categorized by floor or unit, but may be identified by room number alone. Selection of button 570 may result in the data being saved as a logical unit to the healthcare information processing apparatus 103 and/or logical unit circuitry 102. In embodiments in which the user is editing an existing logical unit, the appropriate data may be updated to reflect the changes. The logical unit may therefore be accessed and used to generate a graphical logical unit for subsequent requests.

FIG. 6 is an example display for displaying a graphical logical unit according to some example embodiments. The menu 600 appearing on the left side of the display may provide a hierarchy of available logical units, which may be grouped based on any categories such as locations, creator, purpose (e.g., capacity, bed management, etc.). From the menu 600, a user may select to view a particular logical unit, delete a logical unit, copy a logical unit as a new logical unit, and/or the like.

As shown by indicator 602, in this example, a user has selected to access a logical unit named “Telemetry Units.” The logical unit comprises 25 subunits, as indicated by indicator 604. The subunits identified by the logical unit are visually represented independently from their physical locations relative to one another and/or within a geographic area. In the example graphical logical unit, selected rooms are displayed and grouped by floor number, but without respect to a geospatial arrangement or a floor plan configuration such as provided in FIG. 1. Said differently, although the subunits are grouped by floor number, they are not positioned by geospatial arrangement or by their physical locations, such as according to a floor plan. The rooms are only merely grouped (e.g., placed under a subheading of their respective geographic area (e.g., floor number or identifier)), but not positioned relative to the geographic location of one another, such as according to their respective floor plans. On the other hand, subunits positioned relative to the geographic location of one another, such as in a physical unit, would resemble a floor plan or portion of floor plan such as that of FIG. 1. For example, in FIG. 6, rooms 277, 282, and 283 are displayed in a grouping of subunits on the floor “2 Main,” as shown by indicator 604, but other rooms on “2 Main” are not shown. Furthermore, the rooms 277, 282, and 283 are not positioned relative to the geographic location of one another. According to their respective geospatial arrangements, rooms 282 and 283 would be adjacent while a gap covering the space of 4 rooms would appear between 277 and 282. The graphical logical unit of FIG. 6 eliminates the gap and illustrates rooms 277, 282, and 283 without respect to their geospatial arrangements. Also note that in FIG. 1, room 277 is oriented differently when compared to rooms 282 and 283, but that in FIG. 6, the graphical logical unit presents the subunits in a relatively similar orientation. As such, in some embodiments, the subunits are displayed without respect to their orientations according to their respective geospatial arrangements.

Indicator 606 indicates the number of subunits grouped on the floor or in the specified geographic area described by indicator 606.

As such, in some embodiments, the selected subunits may be a subset of available subunits in which the subset includes less than all of the available subunits. The available subunits may include all rooms on a floor or all rooms in a building, for example. Based on the example graphical logical unit of FIG. 6, only a subset of all available rooms on “2 Main,” “3 Main” and “CVU” are selected as subunits. Further, in some embodiments, at least two of the selected subset of subunits may be physically located remotely from one another; (e.g., rooms 282 and 277 are considered to be located remotely from one another). In other words, the two rooms are not adjacent. In such embodiments, the visual representation may include only the selected subset of subunits, as opposed to all available subunits.

A user may therefore access a consolidated view of pertinent information regarding the selected rooms of interest. In this example, the subunits or rooms are color coded to illustrate room statuses. The assigned staff member for some rooms is also denoted below the visual representation of the subunit (e.g., room). Some particular rooms have associated icons indicating specific alerts or timers. Any of the health information systems 106 may provide the information to the healthcare information processing apparatus 103 and/or logical unit circuitry 102, so that the information may be visually applied to the graphical logical unit and to the appropriate subunit. The graphical logical unit therefore provides pertinent information to a user in a consolidated view, providing an efficient method for managing rooms located in different areas of a building.

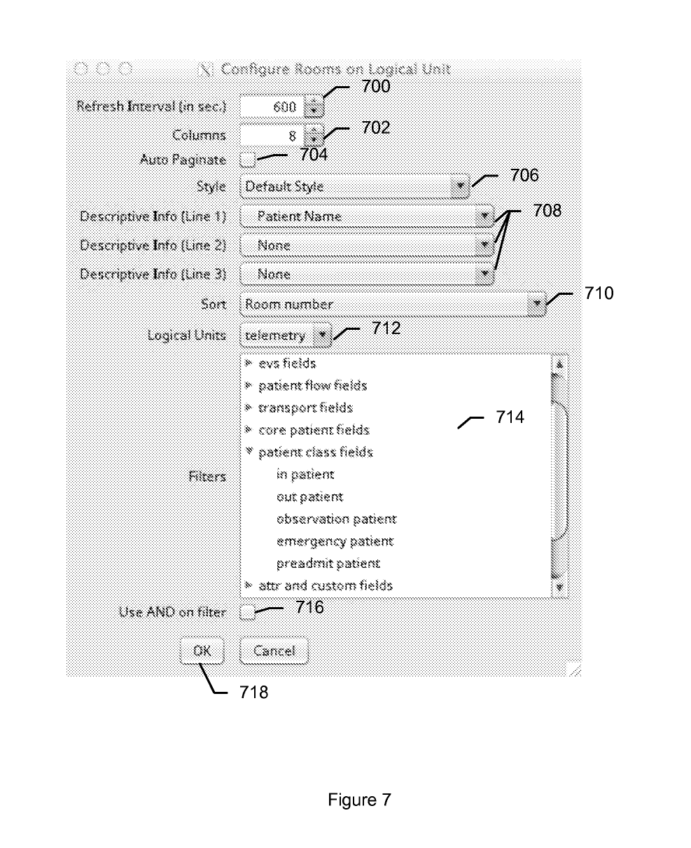

FIG. 7 is an example display used for configuring a graphical logical unit according to some example embodiments. In this regard, a user may access a display such as that of FIG. 7 to customize the graphical logical unit for viewing particular information and/or configurations. As shown by indicator 700, a user may indicate a refresh interval, in seconds, in which the graphical logical unit is updated. The refresh interval may therefore specify how often the information depicted on the graphical logical unit is updated. The healthcare information processing apparatus 103 and/or logical unit circuitry 102 may receive information from health information systems 106 on an ongoing basis, for example. Updates may be made to specific graphical logical units based on the refresh interval. A user working in a fast pace emergency environment may therefore configure refreshes to occur on a relatively short time interval, whereas a user monitoring statuses of stable patients, or the progress of meal service, for example, may configure refreshes to occur less frequently.

As shown by indicator 702, a user may configure the number of columns of subunits to be displayed, and/or auto paginate with indicator 704. Styles with which the graphical logical unit is displayed may be selected, such as with dropdown menu 706. Descriptive information to be displayed on the graphical logical unit, such as patient name, may be selected, such as in dropdown menus 708. The subunits may be sorted according to various factors, such as room number, such as with dropdown menu 710. Dropdown menu 712 allows for selecting specific logical units based on a predefined category. Selection box 714 allows a user to filter the displayed subunits or rooms based on various conditions and/or categorizations. The default use of the selection box 714 may result in subunits meeting any of the filtering requirements being displayed, while selection of indicator 716 may filter the displayed units such that only logical units meeting all the criteria are displayed. Selection of button 718 may cause the graphical logical unit to be displayed, reflecting the configurations entered with the display of FIG. 7. The configuration tool may therefore allow a user to tailor a particular logical unit for the user's personal preferences or practical usage.

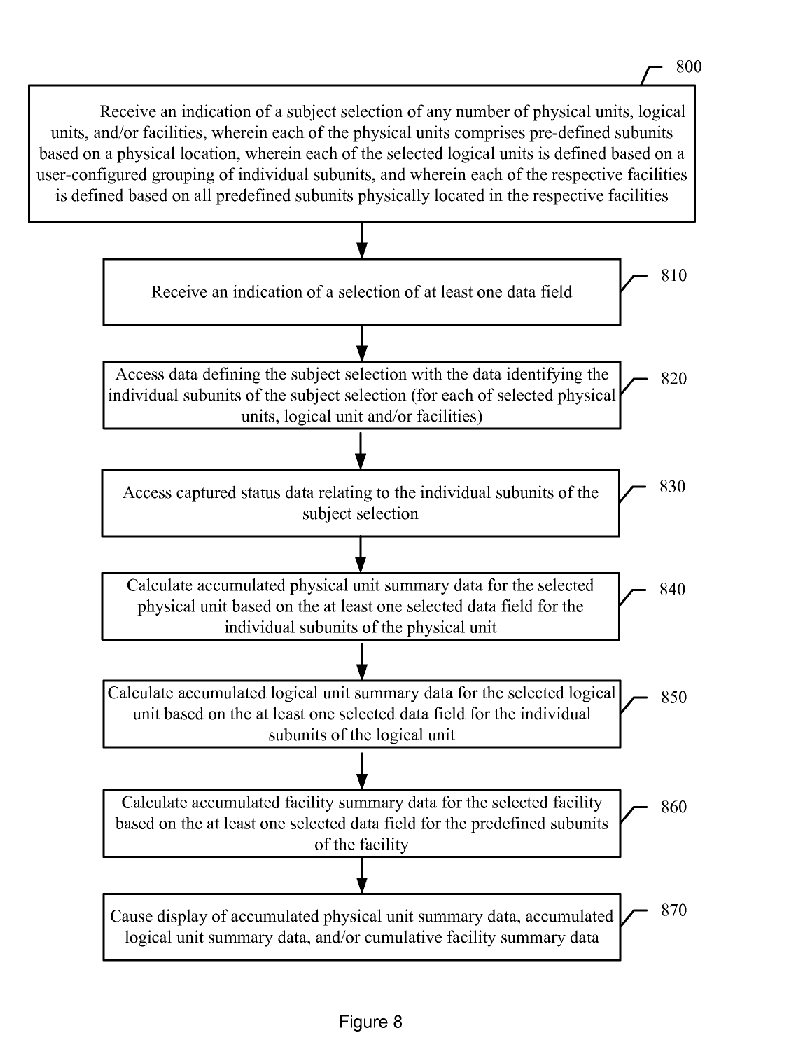

FIG. 8 is a flowchart of operations for assembling hierarchy-independent data relating to geospatial arrangements of health information systems, according to example embodiments. As shown by operation 800, healthcare information processing apparatus 103 and/or hierarchy-independent data assembler 104 may be configured, such as with processor 212, memory 214, user interface 216, communications interface 218 and/or the like, for receiving an indication of a subject selection of any number of physical units, logical units and/or facilities. In this regard, the subject selection indicates the subject physical units, logical units, and/or facilities for which a user requests to view hierarchy-independent data. The subject selection therefore indicates groupings of subunits defined by different hierarchies.

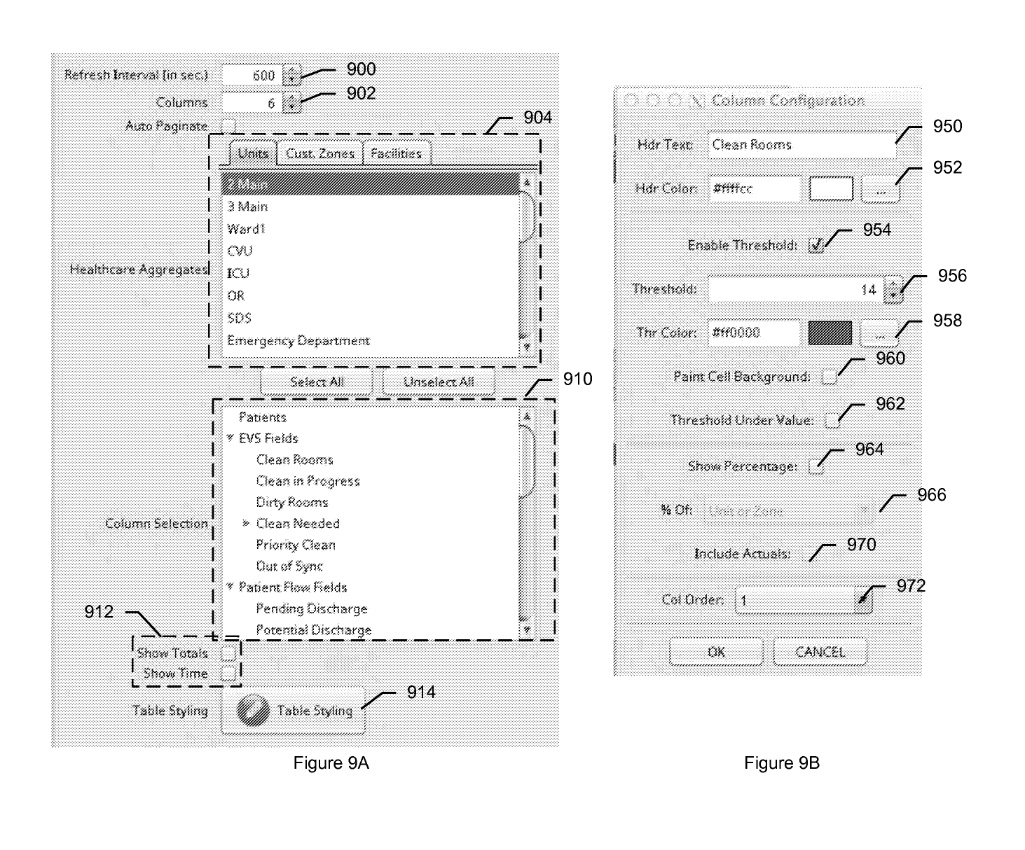

In general, each of the physical units is defined based on a physical location. For example, the physical units may be identified by room numbers and have associated physical locations within a building or facility. Each of the selected logical units may be defined based on a user-configured grouping of individual subunits as described above with respect to FIGS. 4-7, for example. Each of the respective facilities is defined based on all predefined subunits physically located in the respective facilities. More detail regarding physical units, logical units, and/or facilities is provided below with respect to FIG. 9A.

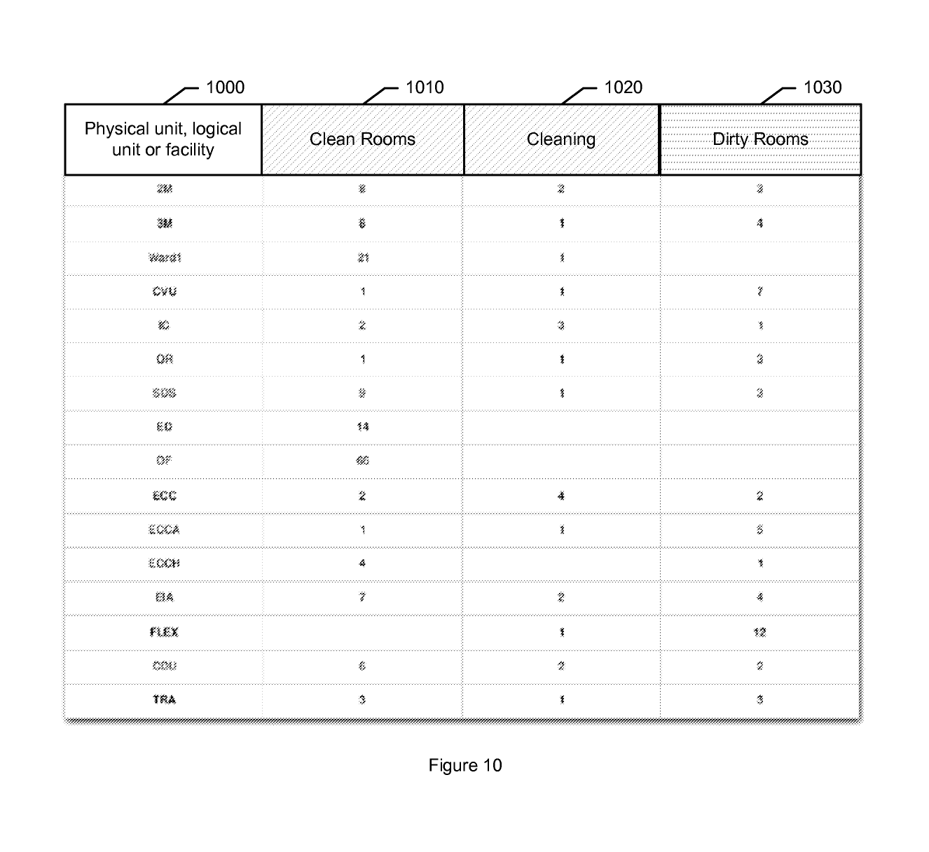

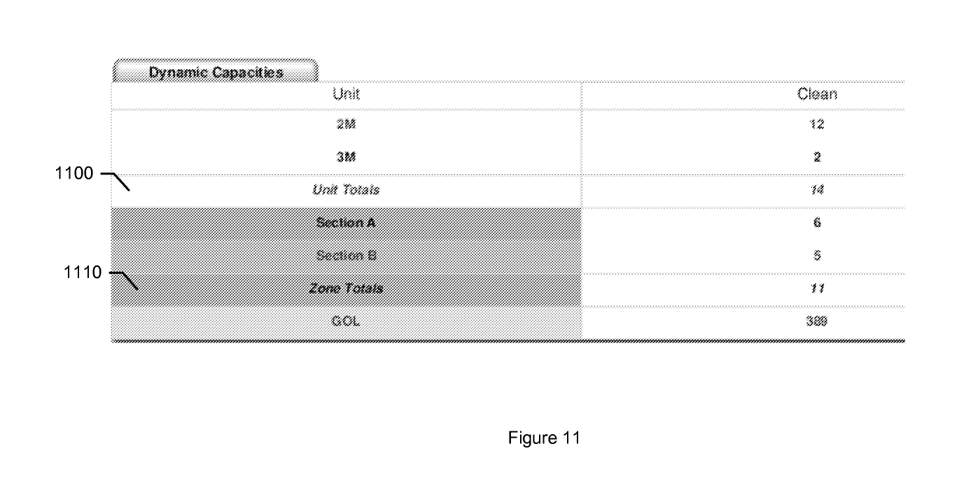

FIGS. 9A and 9B are example user interface displays for enabling a user to make selections as described with respect to the flowchart of FIG. 8 to configure a display of hierarchy independent data such as provided in FIG. 10 and/or FIG. 11. Indicator 900 enables a user to optionally provide a refresh interval at which the hierarchy-independent data assembler 104 will retrieve the most recent hierarchy-independent data, such as from HIS system 106, HIS data repository 108, memory 214, and/or the like. Indicator 902 enables a user to provide a desired number of columns of hierarchy-independent data to view.

As described with respect to operation 800 above, a user may provide a subject selection in area 904. More specifically, in area 904, a user may select any number of physical units (labeled “Units”) in area 904. In this example, the physical units shown include commonly known units such as particular floors or areas of a facility (e.g., 2 Main, 3 Main, Ward1) and clinical units, also defined by their respective physical locations in a building (e.g., cardiovascular unit (CVU), intensive care unit (ICU), etc.). The physical units therefore generally provide meaning to users of the interface such that a particular physical unit of interest may easily be identified. The available physical units may comprise physical units related to physical areas or clinical units of interest.

Also in area 904, a user may select any number of logical units (labeled “Cust. Zones” or “Customized Zones.”) The logical units or customized zones may include configurations of subunits created as described with respect to FIGS. 4-7 above. As an example, the logical units may include more specialized or specific groupings of subunits and are created to provide geospatial arrangements to users who cannot locate the desired data from the physical units alone. With respect to the example user interface of FIG. 9A, a user can therefore select any combination of physical units and/or logical units for which to view hierarchy-independent data.

Additionally, in some examples, a user may also select any number of facilities in area 904. Selecting a facility by name or address, for example, may indicate that the user wishes to view hierarchy-independent data for all subunits in a particular facility or facilities. The user may select any number of physical units, logical units, and/or facilities, and in some examples, may not necessarily provide selections from each of the three hierarchies of physical units, logical units, or facilities.

Returning to FIG. 8, as shown by operation 810, healthcare information processing apparatus 103 and/or hierarchy-independent data assembler 104 may be configured, such as with processor 212, memory 214, user interface 216, communications interface 218 and/or the like, for receiving an indication of a selection of at least one data field. As shown in FIG. 9A, area 910 includes a selectable listing of data fields (labeled “Column Selection”) from which a user may select desired data fields. The data fields may include statuses for which the user desires to see accumulated summary data relative to the selected physical units, logical units, and/or facilities.

Also shown in FIG. 9A are options in area 912 for selecting “show totals” and/or “show time.” A selection of “show totals” indicates the user wishes to view total rows showing ‘Unit Totals’ and ‘Zone Totals’ (e.g., logical unit totals) having associated respective selected statuses of the fields selected in area 910. See FIG. 11, row 1100 of unit totals totaling units 2M and 3M, and row 1110 of zone totals totaling units of Section A and Section B. Returning to FIG. 9A area 912, a selection of “show time” results in a time being displayed with the data.

Also shown in the example interface of FIG. 9A is an option 914 for setting table styles to be used by the healthcare information processing apparatus 103 and/or hierarchy-independent data assembler 104 in displaying the hierarchy-independent data. FIG. 9B provides an additional example user interface for customizing display styles of the hierarchy-independent data, which may be provided to a user in response to selection of option 914 in FIG. 9A. Input 950 allows a user to customize the column name for a selected data field. Indicator 952 allows a user to choose a background color of the column header. Indicator 954 allows a user to indicate whether conditional formatting based on threshold amounts will be configured. For example, in input area 956, the user has entered ‘14’ as a threshold amount. For the selected data item, if a particular physical unit, logical unit, or facility has a count of 14 or more clean rooms, the formatting will change as indicated by a text color 958 and/or background color 960. Color is used as an example and it will be appreciated that any differences in style or formatting may be dynamically applied to visually distinguish the data or respective fields from other fields in the display, as illustrated in FIG. 10 and described hereinafter. Indicator 962 allows a user to optionally indicate that conditional formatting should apply to instances in which the data field falls under the specified threshold amount. In this regard, either a threshold minimum or threshold maximum may be provided, such that when summary data exceeds a threshold maximum or falls below a threshold minimum, the particular summary data is displayed in a distinguished format. Indicator 964 enables display of data and/or summary data as a percentage of a unit or zone (e.g., logical unit) 966. For example, if a user selects to view data relating to clean rooms, and half of the rooms in a selected logical unit were clean, then 50% may be displayed. Additionally or alternatively, a user may select to view percentages of subunits for a selected physical unit, logical unit, or facility meeting the specified criteria, relative to the total number of subunits for selected physical units, logical units, or facilities meeting the criteria. For example, if 2M and 3M are selected, a percentage of clean rooms in 2M relative to the total of clean rooms for 2M and 3M combined may be provided. As another alternative, a user may select a percentage of an entire facility. The data may then show the percentage of clean rooms for the selected physical unit or logical unit relative to an entire facility.

Indicator 970 provides for displaying actual counts along with the percentage values. Indicator 972 provides for a user selecting the column order of the particular selected field.

Returning to FIG. 8, as shown by operation 820, healthcare information processing apparatus 103 and/or hierarchy-independent data assembler 104 may be configured, such as with processor 212, memory 214, and/or the like, for accessing data defining the subject selection (e.g., the selected physical unit(s), logical units, and/or facilities). The data identifies the individual subunits of the subject selection (e.g., the selected physical unit(s), logical units, and/or facilities).

For each physical unit selected in the subject selection, if any, the healthcare information processing apparatus 103 and/or hierarchy-independent data assembler 104 may access data defining the physical units, which may be stored in memory 214, HIS data repository 108, and/or the like. The data defining the physical unit may include a listing of subunits (e.g., room numbers and corresponding facility name, and/or the like).

For each logical unit selected in the subject selection, if any, the healthcare information processing apparatus 103 and/or hierarchy-independent data assembler 104 may access data defining the logical unit, which may be stored in memory 214, logical unit circuitry 102, and/or the like. As described with respect to FIGS. 4-7, a logical unit is defined by a plurality or user-configured selection of subunits. The healthcare information processing apparatus 103 and/or hierarchy-independent data assembler 104 may therefore access, from logical unit circuitry 102, memory 214 and/or the like, the data defining the individual subunits that make up the logical unit(s), such as a listing of room identifiers or the like. As described above, the individual subunits of the user-configured grouping are each defined based on respective physical locations (e.g., by room numbers) and the user-configured grouping is collectively defined without regard to physical locations of the individual subunits (e.g., as individually selected by a user).

For each facility selected in the subject selection, if any, the healthcare information processing apparatus 103 and/or hierarchy-independent data assembler 104 may access data defining the facility, which may be stored in memory 214, HIS data repository 108, HIS(s) 106, and/or the like. In this regard, the healthcare information processing apparatus 103 and/or hierarchy-independent data assembler 104 may access a variety of systems, servers, or apparatuses to access a listing of subunits (e.g., rooms) for entire facilities, for which the user wishes to view hierarchy-independent data, such as status data for facilities as a whole.

In this regard, the facility has a higher hierarchy than a physical unit, because the facility encompasses all subunits in the facility (e.g., building or campus), whereas a physical unit only encompasses a subset of subunits in a facility. A logical unit, may in some examples have a lower hierarchy than a facility, or in some examples, a higher hierarchy than a facility, such as a logical unit that spans multiple facilities.

Therefore, regardless of the number of physical units, logical units, and/or facilities indicated in a subject selection, and the various hierarchies included therein, the healthcare information processing apparatus 103 and/or hierarchy-independent data assembler 104 accesses identifying information of all the subunits defining or making up the physical units, logical units, and/or facilities. In some examples, the subunits making up the physical units, logical units, and/or facilities may be stored on memory 214 such that memory 214 is transformed and may provide for subsequent and/or more efficient retrieval of identifies of the subunits making up the physical units, logical units, and/or facilities.

As shown by operation 830, healthcare information processing apparatus 103 and/or hierarchy-independent data assembler 104 may be configured, such as with processor 212, memory 214, communications interface 216, and/or the like, for accessing captured status data relating to the individual subunits of the subject selection (e.g., the physical units, logical units and/or facilities), based on the selected at least one data field. In this regard, healthcare information processing apparatus 103 and/or hierarchy-independent data assembler 104 may access memory 214, HIS data repository 108, HIS 106, and/or the like to retrieve the requested data for each of the subunits identified in operation 820. The requested data for the selected data field, and for identified subunits of the respective physical units, logical units and/or facilities may be accessed on a variety of databases and/or systems. The healthcare information processing apparatus 103 and/or hierarchy-independent data assembler 104 may, for example, access the requested data from HIS(s) 106, HIS data repository 108, and/or the like, and store the data locally on memory 214.

The captured status data may include real-time or near real-time data as it is provided to respective databases, and/or systems. For example, the indicated data fields from area 910 of FIG. 9A may include a number of clean rooms, or numbers of rooms pending patient discharge.

As shown by operation 840, healthcare information processing apparatus 103 and/or hierarchy-independent data assembler 104 may be configured, such as with processor 212, memory 214, and/or the like, for calculating accumulated physical unit summary data for the selected physical unit based on the at least one selected data field for the individual subunits of the physical unit. For each subunit in the physical unit, the data accessed with regard to operation 830 may be accumulated or summarized such that the data is representative of the physical unit. For example, quantitative data, such as numbers of clean rooms, may be added together to indicate a total sum of clean rooms for the physical unit. In some examples, such those in which the data includes temporal data or timers, the data may be averaged. For example, the healthcare information processing apparatus 103 and/or hierarchy-independent data assembler 104 may calculate an average response time to a request for a room cleaning, for an entire physical unit. In some examples, healthcare information processing apparatus 103 and/or hierarchy-independent data assembler 104 may cause the accumulated physical unit summary data to be written to memory 214. The memory 214 may therefore be transformed to enable subsequent efficient retrieval of accumulated physical unit summary data, such as for display on a user interface 216 as describe in further detail below.

As shown by operation 850, healthcare information processing apparatus 103 and/or hierarchy-independent data assembler 104 may be configured, such as with processor 212, memory 214, and/or the like, for calculating accumulated logical unit summary data for the selected logical unit for the individual subunits of the user-configured grouping. For each subunit in the logical unit, the data accessed with regard to operation 830 may be accumulated or summarized such that the data is representative of the logical unit. For example, quantitative data may be added together to indicate a total sum of subunits in the logical unit meeting a particular condition or category according to a selected data field, or temporal data may be averaged as described above with respect to operation 840. The healthcare information processing apparatus 103 and/or hierarchy-independent data assembler 104 may therefore calculate accumulated logical unit summary data regardless of the hierarchy of the particular logical unit. In some examples, healthcare information processing apparatus 103 and/or hierarchy-independent data assembler 104 may cause the accumulated logical unit summary data to be written to memory 214. The memory 214 may therefore be transformed to enable subsequent efficient retrieval of accumulated logical unit summary data, such as for display on a user interface 216 as describe in further detail below.

As shown by operation 860, healthcare information processing apparatus 103 and/or hierarchy-independent data assembler 104 may be configured, such as with processor 212, memory 214, and/or the like, for calculating accumulated facility summary data for the selected facility based on the at least one selected data field for the predefined subunits of the facility. For each subunit in the logical unit, the data accessed with regard to operation 830 may be accumulated or summarized such that the data is representative of the facility as a whole. For example, quantitative data may be added together to indicate a total sum of subunits in the logical unit meeting a particular condition or category according to a selected data field, or temporal data may be averaged. The healthcare information processing apparatus 103 and/or hierarchy-independent data assembler 104 may therefore calculate accumulated facility summary data for an entire facility, without regard to the physical units and/or logical units in the subject selection and/or otherwise associated with the facility. In some examples, healthcare information processing apparatus 103 and/or hierarchy-independent data assembler 104 may cause the accumulated facility summary data to be written to memory 214. The memory 214 may therefore be transformed to enable subsequent efficient retrieval of accumulated facility summary data, such as for display on a user interface 216 as describe in further detail below.

As shown by operation 870, healthcare information processing apparatus 103 and/or hierarchy-independent data assembler 104 may be configured, such as with processor 212, memory 214, user interface 216, communication interface 218, and/or the like, for causing display of accumulated physical unit summary data, accumulated logical unit summary data, and/or accumulated facility summary data. In some examples, any or all of the accumulated physical unit summary data, accumulated logical unit summary data, and/or accumulated facility summary data is displayed together on a single user interface.

An example interface for displaying hierarchy-independent data is provided in FIG. 10. Column 1000 indicates a particular physical unit, logical unit or facility. For example, 2M, 3M, Ward 1, CVU, IC, and OR may be the names of known physical units. SDS and ED may the user-configured names of logical units created by a user or group of users, while OF is the known name of a facility. The remaining names of the selected subjects may be associated with any physical units, logical units or facilities. In the particular example interface of FIG. 10, the selected data includes clean rooms, rooms undergoing cleaning, and dirty rooms are respectively provided in columns 1010, 1020, and 1030. For each particular physical unit, logical unit and facility listed in column 1000, physical unit summary data, logical unit summary data, and facility summary data are respectively provided for each of columns 1010, 1020, and 1030. In some examples, the formatting of any of the column headers and/or fields displaying data may vary according to the settings provided with the interface of FIG. 9B. For example, any fields may have conditional formatting applied based on the data retrieved.

Furthermore, the assembled hierarchy-independent data may be refreshed according to specified intervals (such as specified with the user interface of FIG. 9A). The data displayed may therefore update to reflect real-time or near real-time data collected and/or accessed via any of the HIS(s) 106, HIS data repository 108, and/or the like.

In some examples, the healthcare information processing apparatus 103 and/or hierarchy-independent data assembler 104 may store the indication of the subject selection in association with the indication of the selection of the at least one data field and a unique identifier of a report. In this regard, a user can name the report so that it may be easily identified. The healthcare information processing apparatus 103 and/or hierarchy-independent data assembler 104 may provide the unique identifier for subsequent retrieval of the report such that the hierarchy-independent data assembler calculates current status data when the report is accessed.

Causing display of the any combination of accumulated physical unit summary data, accumulated logical unit summary data, and/or accumulated facility summary data may provide for improved efficiency and conservation of processing resources by the logical unit circuitry 102, healthcare information processing apparatus 103, and/or hierarchy-independent data assembler. For example, a user may more efficiently access desired data, whereas the user may otherwise need to access several or numerous display screens, export data, perform calculations in other applications, and/or the like. Exporting the data to a client terminal may, for example, especially in scenarios of large volumes of data, may monopolize memory capacity and/or processing power of the logical unit circuitry 102, healthcare information processing apparatus 103, and/or hierarchy-independent data assembler. Providing display of the accumulated physical unit summary data, accumulated logical unit summary data, and/or accumulated facility summary data provides improvements to the logical unit circuitry 102, healthcare information processing apparatus 103, and/or hierarchy-independent data assembler.

As described above, embodiments described herein provide for creation and customization of graphical logical units. Logical units may be configured such that a user may view information regarding only the subunits or rooms the user is interested in monitoring. A user may further customize views of hierarchy independent data, so that a user may view desired status data, regardless of the hierarchy of such data.

Therefore, users at all levels of an organization, such as healthcare organization or hospital network, and/or the like, can easily access real-time data pertinent to their roles within the organization. For example, a nurse working in a hospital may wish to view data relating to the nurse's assigned physical unit, but may also customize a logical unit based on a few rooms for which the nurse cares for patients outside the nurse's assigned unit. The nurse may not require viewing of summary data for the facility as a whole. The nurse's customized view of hierarchy-independent data may therefore include fine-grained summary data pertaining to a relative small number of subunits.

As another example, a hospital administrator may wish to view data by physical units, and the facility as a whole. An administrator of an entire healthcare network, on the other hand, may customize views of hierarchy-independent data such that the administrator can view data pertaining to all the facilities within the network, on the physical unit level and facility level. The administrator's view may therefore include a high-level summary of facility data, where the status data pertaining to individual subunits is less important but the overall operation of the facilities needs to be monitored.

Furthermore, embodiments provided herein provide numerous technical advantages including the conservation of processing resources and the associated power consumption otherwise expended to support the display of various different views of data relating to various physical units and/or groupings of subunits. For example a user may otherwise need to export the desired data for individual subunits to a spreadsheet application or similar, and manipulate and organize the data as desired. Such methods require significantly more processing power and memory capacity than the methods, computer program product, and apparatuses provided herein. The logical unit circuitry 102, healthcare information processing apparatus 103, and hierarchy-independent data assembler 104 as described herein provide efficient configuration and assembly of hierarchy-independent data to meet the needs of every user, regardless of position or level within an organization and with minimal use of processing resources compared to alternative implementations.

FIGS. 4 and 8 illustrate operations of a method, apparatus, and computer program product according to some example embodiments. It will be understood that each operation of the flowcharts or diagrams, and combinations of operations in the flowcharts or diagrams, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may comprise one or more memory devices of a computing device (for example, memory 214) storing instructions executable by a processor in the computing device (for example, by processor 212). In some example embodiments, the computer program instructions of the computer program product(s) which embody the procedures described above may be stored by memory devices of a plurality of computing devices. As will be appreciated, any such computer program product may be loaded onto a computer or other programmable apparatus (for example, logical unit circuitry 102, healthcare information processing apparatus 103, hierarchy-independent data assembler 104, HIS 106, and/or client terminal 110) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product may comprise an article of manufacture which implements the function specified in the flowchart block(s). The computer program instructions of one or more computer program products may also be loaded onto a computer or other programmable apparatus (for example, logical unit circuitry 102, healthcare information processing apparatus 103, hierarchy-independent data assembler 104, HIS 106, client terminal 110, and/or other apparatus) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A healthcare information processing apparatus for assembling hierarchy-independent data relating to geospatial data of a health information system, the healthcare information processing apparatus comprising processing circuitry configured to cause the healthcare information processing apparatus to perform at least:
receiving an indication of a subject selection comprising at least one of each of a physical unit and a logical unit, wherein each of the physical units is defined based on a physical location, and wherein each of the selected logical units is defined based on a user-configured grouping of individual subunits;
receiving an indication of a selection of at least one data field;
accessing data defining the subject selection, wherein the data identifies the individual subunits of the subject selection;
accessing captured status data associated with the selected at least one data field and relating to the individual subunits of the subject selection;
calculating accumulated physical unit summary data for the selected physical unit based on the at least one selected data field for the individual subunits of the physical unit;
calculating accumulated logical unit summary data for the selected logical unit based on the at least one selected data field for the individual subunits of the user-configured grouping; and
causing display of the accumulated physical unit summary data for the selected physical unit with the accumulated logical unit summary for the selected logical unit.

2. The healthcare information processing apparatus of claim 1, wherein the individual subunits of the logical unit are each defined based on respective physical locations and the logical unit is collectively defined without regard to the physical locations of the individual subunits.

3. The healthcare information processing apparatus of claim 1, wherein the processing circuitry is further configured to cause the healthcare information processing apparatus to perform at least:
storing the indication of the subject selection in association with the indication of the selection of the at least one data field and a unique identifier of a report;
providing the unique identifier for subsequent retrieval of the report; and
in response to subsequent retrieval of the report, calculating current status data.

4. The healthcare information processing apparatus of claim 1, wherein the subject selection further comprises at least one facility, wherein each of the respective facilities is defined based on all predefined subunits physically located in the respective facility, and the processing circuitry is further configured to cause the healthcare information processing apparatus to perform at least:
accessing captured status data relating to each of the predefined subunits of the respective facilities;
calculating accumulated facility summary data for the at least one selected facility based on the at least one selected data field for the predefined subunits; and
causing display of the accumulated facility summary data for the at least one selected facility with the displayed accumulated logical unit summary data for the selected logical unit and the accumulated physical unit summary data relating to the directly selected physical units.

5. The healthcare information processing apparatus of claim 1, wherein the processing circuitry is further configured to cause the healthcare information processing apparatus to perform at least:
receiving an indication of at least one of a threshold minimum or threshold maximum associated with at least one selected data field; and
in response to any of accumulated logical unit summary data or accumulated physical unit summary data exceeding the threshold maximum or falling below the threshold minimum, causing display of the respective accumulated logical unit summary data or accumulated physical unit summary data in a distinguished format.

6. The healthcare information processing apparatus of claim 1, wherein the at least one selected data field comprises a temporal data field, and an associated accumulated summary data comprises an average time.

7. The healthcare information processing apparatus of claim 1, wherein the at least one selected data field comprises a quantitative data field, and an associated accumulated summary data comprises a sum.

8. A method for assembling hierarchy-independent data relating to geospatial data of a health information system, the method comprising:
receiving an indication of a subject selection comprising at least one of each of a physical unit and a logical unit, wherein each of the physical units is defined based on a physical location, and wherein each of the selected logical units is defined based on a user-configured grouping of individual subunits;
receiving an indication of a selection of at least one data field;
accessing data defining the subject selection, wherein the data identifies the individual subunits of the subject selection;
accessing captured status data associated with the selected at least one data field and relating to the individual subunits of the subject selection;
calculating accumulated physical unit summary data for the selected physical unit based on the at least one selected data field for the individual subunits of the physical unit;
calculating accumulated logical unit summary data for the selected logical unit based on the at least one selected data field for the individual subunits of the user-configured grouping; and
causing display of the accumulated physical unit summary data for the selected physical unit with the accumulated logical unit summary for the selected logical unit.

9. The method of claim 8, wherein the individual subunits of the logical unit are each defined based on respective physical locations and the logical unit is collectively defined without regard to the physical locations of the individual subunits.

10. The method of claim 8, further comprising:
storing the indication of the subject selection in association with the indication of the selection of the at least one data field and a unique identifier of a report;
providing the unique identifier for subsequent retrieval of the report; and
in response to subsequent retrieval of the report, calculating current status data.

11. The method of claim 8, wherein the subject selection further comprises at least one facility, wherein each of the respective facilities is defined based on all predefined subunits physically located in the respective facilities, and the method further comprises:
accessing captured status data relating to each of the predefined subunits of the respective facilities;
calculating accumulated facility summary data for the at least one selected facility based on the at least one selected data field for the predefined subunits; and
causing display of the accumulated facility summary data for the at least one selected facility with the displayed accumulated logical unit summary data for the selected logical unit and the accumulated physical unit summary data relating to the directly selected physical units.

12. The method of claim 8, further comprising:
receiving an indication of at least one of a threshold minimum or threshold maximum associated with at least one selected data field; and
in response to any of accumulated logical unit summary data or accumulated physical unit summary data exceeding the threshold maximum or falling below the threshold minimum, causing display of the respective accumulated logical unit summary data or accumulated physical unit summary data in a distinguished format.

13. The method of claim 8, wherein the at least one selected data field comprises a temporal data field, and an associated accumulated summary data comprises an average time.

14. The method of claim 8, wherein the at least one selected data field comprises a quantitative data field, and an associated accumulated summary data comprises a sum.

15. A computer program product for assembling hierarchy-independent data relating to geospatial data of a health information system, the computer program product comprising at least one non-transitory computer-readable medium having computer-readable program instructions stored therein, the computer-readable program instructions comprising instructions, which when performed by an apparatus, are configured to cause the apparatus to perform at least:
receiving an indication of a subject selection comprising at least one of each of a physical unit and a logical unit, wherein each of the physical units is defined based on a physical location, and wherein each of the selected logical units is defined based on a user-configured grouping of individual subunits,
receiving an indication of a selection of at least one data field;
accessing data defining the subject selection, wherein the data identifies the individual subunits of the subject selection;
accessing captured status data associated with the selected at least one data field and relating to the individual subunits of the subject selection;
calculating accumulated physical unit summary data for the selected physical unit based on the at least one selected data field for the individual subunits of the physical unit;
calculating accumulated logical unit summary data for the selected logical unit based on the at least one selected data field for the individual subunits of the user-configured grouping; and
causing display of the accumulated physical unit summary data for the selected physical unit with the accumulated logical unit summary for the selected logical unit.

16. The computer program product of claim 15, wherein the individual subunits of the logical unit are each defined based on respective physical locations and the logical unit is collectively defined without regard to the physical locations of the individual subunits.

17. The computer program product of claim 15, wherein the computer-readable program instructions further comprise instructions, which when performed by the apparatus, are configured to cause the apparatus to perform at least:
storing the indication of the subject selection in association with the indication of the selection of the at least one data field and a unique identifier of a report;
providing the unique identifier for subsequent retrieval of the report; and
in response to subsequent retrieval of the report, calculating current status data.

18. The computer program product of claim 15, wherein the subject selection further comprises at least one facility, wherein each of the respective facilities is defined based on all predefined subunits physically located in the respective facilities, and the computer-readable program instructions further comprise instructions, which when performed by the apparatus, are configured to cause the apparatus to perform at least:
accessing captured status data relating to each of the predefined subunits of the respective facilities;
calculating accumulated facility summary data for the at least one selected facility based on the at least one selected data field for the predefined subunits; and
causing display of the accumulated facility summary data for the at least one selected facility with the displayed accumulated logical unit summary data for the selected logical unit and the accumulated physical unit summary data relating to the directly selected physical units.

19. The computer program product of claim 15, wherein the computer-readable program instructions further comprise instructions, which when performed by the apparatus, are configured to cause the apparatus to perform at least:
receiving an indication of at least one of a threshold minimum or threshold maximum associated with at least one selected data field; and
in response to any of accumulated logical unit summary data or accumulated physical unit summary exceeding the threshold maximum or falling below the threshold minimum, causing display of the respective accumulated logical unit summary data or accumulated physical unit summary in a distinguished format.

20. The computer program product of claim 15, wherein the at least one selected data field comprises a temporal data field, and an associated accumulated summary data comprises an average time.
